(19) United States
(12) Patent Application Publication
(10) Pub. No.: US 2013/0243915 A1
(43) Pub. Date: Sep. 19, 2013

(54) FOOD PRODUCT STABILIZER APPARATUS AND METHOD

(71) Applicants: Ralph C. Obert, Mableton, GA (US); John Christopher Kline, Marietta, GA (US); Simon Shamoun, Acworth, GA (US)

(72) Inventors: Ralph C. Obert, Mableton, GA (US); John Christopher Kline, Marietta, GA (US); Simon Shamoun, Acworth, GA (US)

(21) Appl. No.: 13/613,499

(22) Filed: Sep. 13, 2012

Related U.S. Application Data
(63) Continuation-in-part of application No. 12/332,586, filed on Dec. 11, 2008, now abandoned.
(60) Provisional application No. 61/107,835, filed on Oct. 23, 2008.

(51) Int. Cl. A23B 4/18

(52) U.S. Cl. CPC A23B 4/18
USPC 426/295; 426/442; 426/327; 426/302; 426/393; 426/324; 426/438; 426/532; 426/644; 62/62; 62/322

(57) ABSTRACT

An apparatus for processing a food product includes an ingredient station for providing ingredients into the food product; an impingement freezer downstream from the ingredient station for reducing a temperature of a surface of the food product to provide a frozen crust at said surface to retain the ingredients in the food product and adapt the food product to retain deformation to a select shape; and a press excluding a cutter disposed downstream of the impingement freezer for pressing the food product to the select shape, wherein the frozen crust retains the select shape of and the ingredients in the food product. A method for processing the food product is also provided.

### BACKGROUND OF THE INVENTION

The present invention relates to stabilizing food products for treatment and processing.

Known processes for food products include pressing the food product, such as by mechanical presses, and various forms of treatment to physically arrange the product in a predetermined manner for subsequent processing. In particular, when the food product is injected with for example ingredients such as marinates or other treatment solutions, it is important that the ingredients are retained in the food product during subsequent processing, even during pressing the food product. Unfortunately, this is not carried out with known systems. In other words, it is desirable not to permit a “purge out” of any marinates or solutions that have been injected into the food product.

In addition, since the food product is sized for a particular end use, it is important that a resulting yield is maintained for the food product so that subsequent processing is efficient and cost effective, i.e. the product remains in the same physical form (doesn't “rebound”) through the processing line without loss of any of the product, compromise of product dimensions, or loss of any solutions or ingredients incorporated therein. Known systems do not provide for these processing requirements.

Further, known processes heat or cook the food product before same is frozen.

### BRIEF DESCRIPTION OF THE DRAWINGS

For a more complete understanding of the embodiments of the present invention, reference may be had to the following drawings, taken in conjunction with the description of the invention, of which:

FIG. 1 shows a flow chart of an embodiment of the method of the present invention for use with food products.

FIG. 2 shows an embodiment of an apparatus of the invention for use with food products.

FIGS. 3 and 4 show an injection station or assembly of the apparatus of FIG. 2.

FIG. 5 shows a tumbler station or assembly for use with the embodiment of FIG. 2.

FIG. 6 shows a pressing station of the embodiment of FIG. 2.

### DESCRIPTION OF THE INVENTION

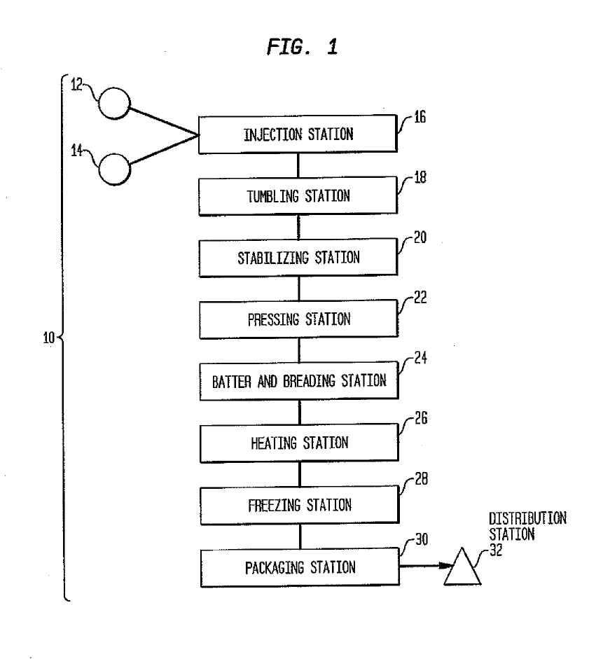

Referring to FIG. 1, a flow chart for a stabilizing method embodiment of the present invention is shown generally at 10. A food product is stabilized for processing by the method of the invention. The method 10 is for processing a myriad of different food products such as for example chicken breast patties 12 and other meat or fish patties 14, collectively referred to herein as food products. The food products 12,14 can be for example boneless chicken breasts of marinated breast meat for use in retail sandwiches. For the sake of brevity and by way of example only, reference herein will be with respect to a boneless chicken breast food product 12.

The food product 12 or product is cut and measured having particular dimensions for being introduced into the method 10 for batch or continuous processing. The method may also be used with products 12 that are of the IQF-type, i.e. individually quick frozen type.

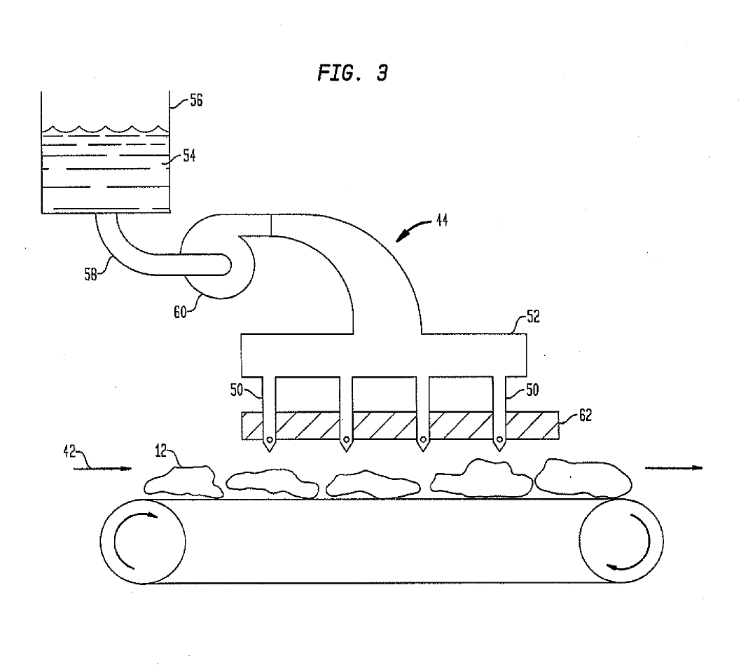

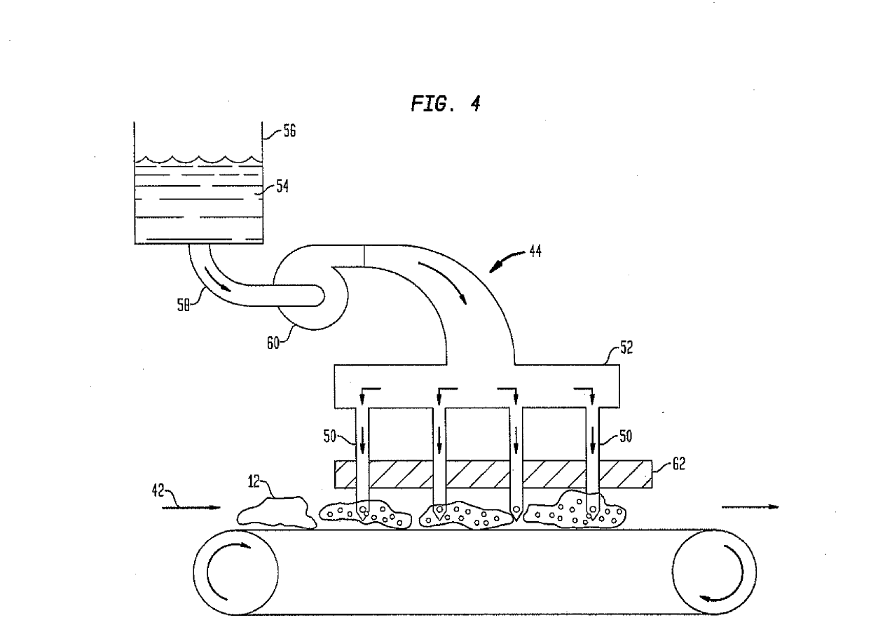

The method 10 includes an injection station 16, wherein the product 12 is infused such as by injection with marinades, perhaps antibiotics, and/or other fluids, ingredients or compositions to maintain or improve the organoleptic qualities of food products, i.e. the taste, color, odor freshness and mouth feel of the food product 12. The injection station 16 is discussed in more detail with respect to FIGS. 3-4, efficiently infuses the product 12 with the marinades, antibiotics, bacteria inhibitors, antimicrobials or other ingredients, such as flavors and preservatives. The injection station 16 is used in those instances where the marinade or other liquid to be injected into the product 12 is substantially free of particulate matter and is not highly viscous.

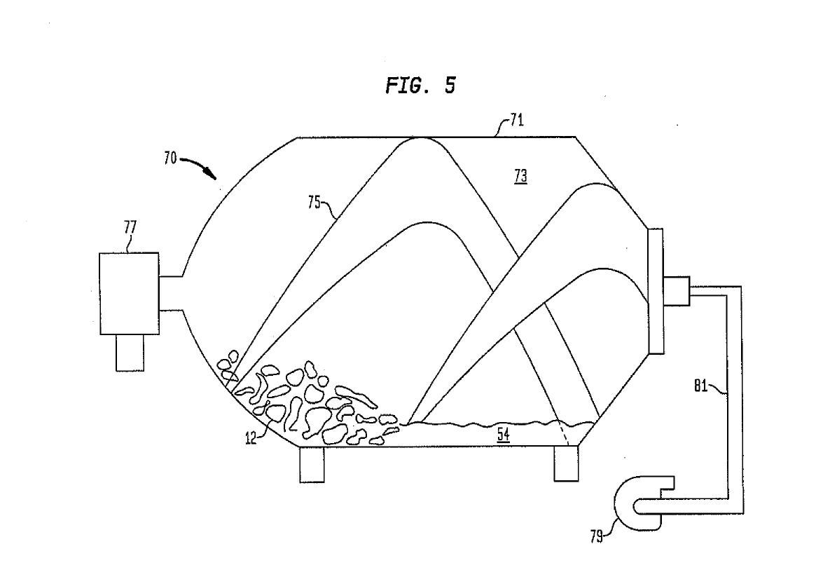

The product 12 then proceeds to a tumbling step 18, wherein the product may be vacuum tumbled and chilled in a rotating tumbler system. In addition to the injection station 16 or alternatively, the tumbling station can be used in those instances where the marinade or ingredients to be infused into the product 12 have a large amount of particulate matter in solution or are highly viscous. Therefore, with the vacuum tumbling station, it takes much longer for the marinade or the ingredient to be absorbed into the product 12. Therefore, injection and tumbling may each be performed to the exclusion of the other, or both may be performed in sequence on the product 12. Injection can be performed on the product 12 before tumbling or vice versa, but regardless of which are used or the order of use, each occurs prior to stabilizing and pressing the product. The tumbling station is further discussed with respect to FIG. 5.

The product 12 is then transferred to a stabilizing step 20 of the invention. The stabilizing step 20 processes the product 12 so that it will not “rebound”, i.e. will not return to its original, undesirable shape and/or thickness. In the stabilizing step 20, the product 12 is chilled with cooling or freezing technology, such as for example impingement or immersion freezing technology, after at least one of the injection step 16 and the tumbling step 18. The stabilizing step employing the cryogen chilling technology, such as cryogen impingement chilling, insures that the food product 12 maintains its shape during subsequent processing steps of the method 10 and retains any marinades, ingredients or other fluids earlier injected (or tumbled) into the product 12 prior to the stabilizing step 20. The stabilizing step increases the surface firmness of the product 12 and substantially reduces if not eliminates product rebounding to its original shape during subsequent processing. With the present embodiments, the product 12 is crust frozen at its surface before any heating of the product.

Impingement freezer technology is one manner of stabilizing the product 12 during the stabilizing step 20, although other chilling technologies may be employed on the product 12. The stabilizing step 20 of cooling or freezing provides a crust, such as for example a 1/16″ crust, of the product 12 at its surface or surface area. The crust retains any fluids, such as marinades, which have been injected or tumbled earlier into the product 12 so that said fluids remain in the product during the subsequent pressing step 22. The crust also helps to substantially reduce if not eliminate the product 12 from rebounding to its original shape during subsequent processing. Thus, the stabilizing step 20 permits the product 12 to retain the deformed shape selected for the product after the pressing step.

Accordingly, use of the stabilizing step 20 after the product 12 has been subjected to the injection step 16 and/or the tumbling step 18, but before the product 12 is subject to the pressing step 22, prevents product rebound and loss of that which was previously injected or absorbed into the product 12.

During the pressing step 22, the product 12 is pressed to selected dimensions. It is possible to include a subsequent batter and breading step 24 after the pressing. The previous stabilizing step 20 prevents the product 12 from losing that which was previously injected or absorbed into the product and insures that the product retains its shape after being pressed during the step 22. The batter and breading step 24 provides for example a pre-dust, batter and bread coating process prior to a heating step for the product 12. The pressing step 22 includes a particular type of action upon the product 12. That is, the term “pressing” as used herein refers to exerting pressure on a body (such as the product 12) for the purpose of shaping said body, but excluding cutting the body. The term “press” as used herein with respect to the apparatus embodiments of the present invention refers to a machine or apparatus by which a substance or body, such as the product 12, is shaped upon application of pressure without cutting. The pressing apparatus may also include a mold to render or form the body into a select shape, but is not constructed with a cutting instrument or operated for cutting the product 12.

Thereafter the product may be cooked, in a heating step 26, such as by frying by heat from a heat assembly.

The product 12 may then be subjected to a freezing step 28, after which the product 12 is packaged in a packaging step 30 for subsequent distribution 32.

All the while subsequent to the stabilizing step 20, the product retains its shape since the pressing step 22 and retains any ingredients, compositions, fluids or marinades, etc. injected or absorbed therein.

The use of the method 10, delivers improved product 12 quality and operational savings to plant processors by reducing re-work of the food product 12 (no product rebound or loss of product ingredients), increased yield benefits, along with increased flexibility and throughput.

An impingement freezer or an immersion freezer may be used for the stabilizing step 20. Impingement freezing includes applying cryogenic spray or a fluid stream to a food product to freeze all or a portion of the product 12. Immersion freezing includes immersing the product 12 into a cryogen fluid for freezing all or a portion of the product 12. The cryogenic fluid used for impingement freezing may be either nitrogen or carbon dioxide; while nitrogen is used in immersion freezing. The impingement freezer technology provides for more efficient use of the cryogen, such as for example nitrogen, as a medium to crust a surface of the food product 12. Impingement and immersion freezer technology and systems are available from Linde LLC of New Jersey USA.

The steps of the method 10 discussed herein can occur in any sequence although the stabilizing step (cooling or freezing) 20 must occur before the pressing step 22.

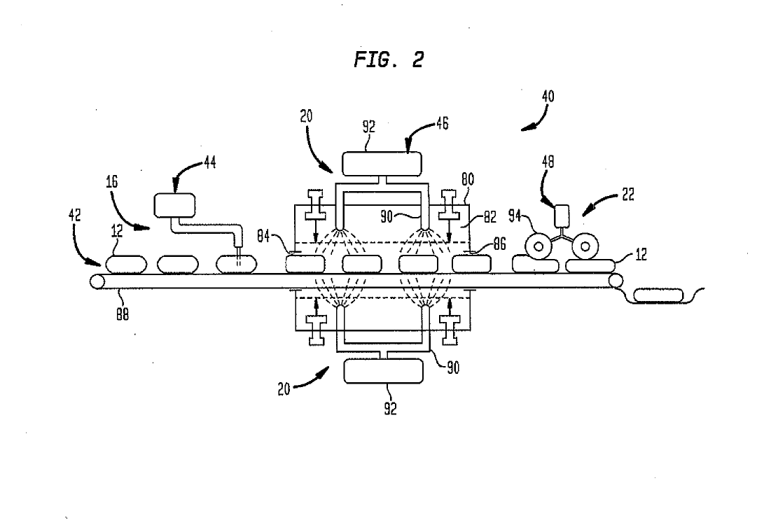

A stablizing apparatus 40 is also provided for processing the product 12 as shown in FIG. 2. Components or subsequent stations of the apparatus 40 are shown in FIGS. 3-6. The apparatus 40 provides a processing line 42 which includes at least an injector 44, an impingement freezer 46, followed by a press 48.

Referring also to FIGS. 3 and 4, the injector 44 includes at least one and for most applications a plurality of injection needles 50 mounted to and in communication with a plenum 52 through which ingredients 54, such as for example marinade are provided from a remote container 56 or vessel. A pipe 58 or conduit in communication with the container 56 is connected to the plenum 52 and a pump 60 is used to transfer the marinade 54 in a controlled manner to the plenum 52. As shown in FIGS. 3-4, the plenum 52 can be lowered or deployed in a timed manner of operation such that each one of the plurality of needles 50 contacts and is inserted into a corresponding one of the products 12 in registration therewith. Upon insertion of the needles 50 to a correct depth within the product 12, the pump 60 injects a preselect amount of the marinade or ingredients through the plenum 52 and the needles 50 into the product 12 for a select period of time, after which the plenum is retracted or raised allowing the product 12 to continue on its way along the processing line 42. The injection of the marinade into the product 12 occurs in a relatively short period of time, such as, by way of example only, 0.1-20 seconds, so as not to unnecessarily delay the processing line 42. The plenum 52 may include a guard 62 through which the needles 50 pass as shown in FIGS. 3-4. The guard 62 is stationary and prevents the products 12 from traveling or being retracted with the needles 50 when same are retracted after an injection cycle.

Alternatively, as opposed to the injector 44, a tumbler 70, such as a vacuum tumbler, may be used to provide the marinades 54 or other liquid ingredients into the product 12 as shown in FIG. 5. The tumbler 70 includes a vessel 71 or drum with a chamber 73 therein in which blades 75 are disposed to churn the product 12 and ingredients 54 to be mixed into the product. A motor 77 rotates the vessel 71, and a pump 79 draws atmosphere from the chamber 73 through a pipe 81 to provide the vacuum in the chamber. The tumbler 70 preferably uses a vacuum which permits the product 12 to more readily absorb the ingredients 54, such as the marinade, which will produce a juicer and faster cooking of product. Marinating in the tumbler in which a vacuum is provided causes the marinade to penetrate evenly throughout the product 12, which eliminates flavor “hot spots” and “dead zones” of the flavor. The massaging action as a result of the rotational movement of the tumbler makes the product 12 much more tender. The vacuum, as mentioned above, permits pores of the product 12 to open or expand to more readily accept the ingredients 54, such as marinade or water.

With thicker cuts of the product 12, sometimes the tumbler 70 is used subsequent to the injector 44 to more rapidly achieve flavor equilibrium in thicker cuts of the product 12.

Referring again to FIG. 2, the impingement freezer 46 includes a housing 80 having a chamber 82 therein, which is known in the industry as a tunnel, and an inlet 84 and an outlet in communication with the chamber. A conveyor device, such as a conveyor belt 88, is constructed and arranged to move through the chamber 82 to transfer the product 12 from the inlet 84 through the chamber to the outlet 86 where the product is discharged for subsequent processing, such as with devices to carry out the steps 24-32. At least one cryogen injection nozzle 90 is disposed in the chamber 82 for providing cryogenic substance to the product 12 as it is transferred through the chamber by the conveyor 88. The nozzle 90 is connected to a remote source 92 of cryogen which may be liquid nitrogen or liquid CO₂. A plurality of the nozzles 90 may be used in the chamber 82; disposed to provide the most effective coverage to the product 12 requiring processing. The liquid CO₂ cryogen “flashes” upon contacting the warmer atmosphere of the chamber 12 so that a combination solid-gaseous phase of a cryogenic spray contacts the product 12 to freeze and crust the product surface. The liquid CO₂ will flash through the nozzle 90 into a combination of solid (dry ice/snow) and gas. The solid (dry ice snow) will then flash directly to a gaseous state as it absorbs heat from the product 12 to be chilled or frozen. The liquid nitrogen will flash from the liquid state to a combination of liquid and gaseous nitrogen, and the liquid portion will again flash as it absorbs the heat from the product 12 being chilled or frozen.

An alternate embodiment of the apparatus 40 calls for the conveyor belt 88 to be of the mesh variety or any other construction having holes therethrough such that the cryogenic substance can be sprayed from underneath the conveyor belt to crust a lower side of the product 12 as shown in FIG. 2. That is, other ones of the nozzles 90 may be disposed beneath the conveyor belt 88 to provide the cryogenic substance from beneath the products to “flash” the cryogen and crust a lower surface of the product while the upper surface area of the product is being crust frozen by the nozzles 90 there above. The result is that the product 12 exiting the outlet 86 is completely crust frozen along its exterior surface and ready for the press 48.

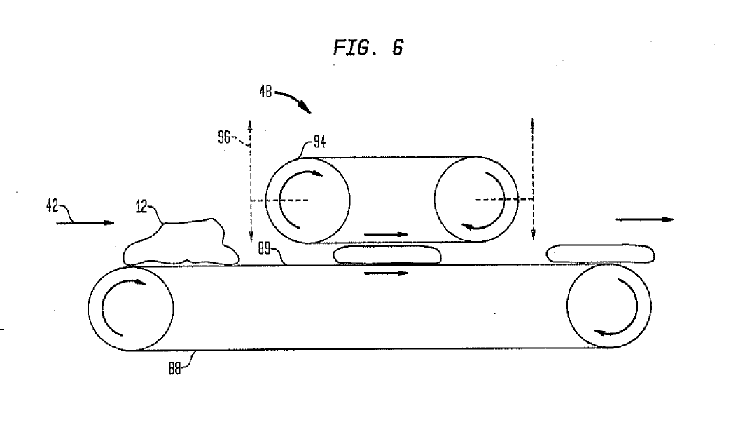

Referring to FIGS. 2 and 6, the press 48 can be for example a type that consists of a smooth surface rotatable drum 94 which forces the product into a desired shape. Such a press is available from Food Processing Equipment Co. of Springfield, Ark. USA, model no. MMP-64. The press 48 is disposed downstream of the impingement freezer 44 and preferably immediately thereafter in the processing line 42 for the product 12. The drum 94 or drums are adjustable with respect to the distance from a surface 89 of the conveyor belt 88 as shown by arrows 96 in order to vary the extent of pressure applied to the product 12 to adjust the product thickness and shape of the product upon exiting the press 48.

An embodiment of the invention also includes a product of the process of the method 10 of the invention.

It will be understood that the embodiments described herein are merely exemplary and that a person skilled in the art may make many variations and modifications without departing from the spirit and scope of the invention. All such variations and modifications are intended to be included within the scope of the invention as described and claimed herein. It should be understood that the embodiments described herein are not only in the alternative, but may be combined.

What is claimed is:

1. An apparatus for processing a food product, comprising:
an ingredient station for providing ingredients into the food product;
an impingement freezer downstream from the ingredient station for reducing a temperature of a surface of the food product to provide a frozen crust at said surface to retain the ingredients in the food product and adapt the food product to retain deformation to a select shape; and
a press excluding a cutter disposed downstream of the impingement freezer for pressing the food product to the select shape, wherein the frozen crust retains the select shape of and the ingredients in the food product.

2. The apparatus of claim 1, wherein the impingement freezer comprises at least one nozzle disposed in the freezer for providing a cryogenic substance selected from the group consisting of nitrogen and carbon dioxide to the surface of the food product.

3. The apparatus of claim 1, wherein the ingredient station comprises an injector apparatus having at least one needle constructed and arranged to deliver an ingredient into the food product.

4. The apparatus of claim 1, wherein the ingredient station comprises a tumbler apparatus constructed and arranged to receive the food product for tumbling the ingredients into said food product.

5. The apparatus of claim 1, wherein the ingredients are selected from the group consisting of marinades, antibiotics, antimicrobials, bacteria inhibitors, fluids, flavor ingredients, preservatives and combinations thereof.

6. The apparatus of claim 1, wherein the press comprises at least one roller to press the crusted food product into the select shape.

7. The apparatus of claim 1, wherein the press is disposed immediately downstream of the impingement freezer.

8. A method for processing a food product, comprising in sequence:
providing into the food product ingredients selected from the group consisting of marinades, antibiotics, antimicrobials, bacteria inhibitors, fluids, flavor ingredients, preservatives and combinations thereof;
reducing a temperature of a surface of the food product to crust said surface to retain the ingredients within the food product and adapt the food product for retaining deformation to a select shape; and
pressing the food product to the select shape, wherein the pressing excludes cutting, such that the shape of the food product and the ingredients in the food product are retained for subsequent processing.

9. The method of claim 8, wherein the providing the ingredients comprises injecting the ingredients into the food product.

10. The method of claim 8, wherein the providing the ingredients comprises tumbling the food product in the ingredients.

11. The method of claim 8, wherein the reducing the temperature comprises providing to the food product a cryogenic substance selected from the group consisting of nitrogen and carbon dioxide.

12. The method of claim 8, wherein the reducing the temperature comprises providing the crust formed to a depth of up to one-sixteenth of an inch at the surface of the food product.

13. The method of claim 8, further comprising after the pressing at least one of:
coating the food product with a composition selected from batter, breading and combinations thereof;
heating the food product;
freezing the food product; and
packaging the food product.

14. The method of claim 13, wherein the heating is selected from at least one of cooking and frying the food product.

15. A food product produced by the method of claim 8.
